(19) United States
(12) Patent Application Publication
(10) Pub. No.: US 2015/0231496 A1
(43) Pub. Date: Aug. 20, 2015

(54) Non-transitory computer-readable medium storing a program and a server

(71) Applicant: LINE Corporation, Tokyo (JP)

(72) Inventors: Heechan YANG, Tokyo (JP); Youngsu KO, Sung Nam-si (KR)

(21) Appl. No.: 14/621,964

(22) Filed: Feb. 13, 2015

(30) Foreign Application Priority Data
Feb. 17, 2014 (JP) 2014-027464

(51) Int. Cl. A63F 13/35

(52) U.S. Cl. CPC A63F 13/35

(57) ABSTRACT

A non-transitory computer-readable medium storing a program for causing a computer to execute a process, includes sending first data for setting at least one second user to be an opponent of a game and a match time of the game to a server based on an instruction input by a first user, displaying a screen of the game, and receiving second data according to a result of the game of the first user in a collection period determined based on the match time from the server and displaying game result information in a chat screen for chatting in a group including the first user and the second user based on the second data.

### CROSS-REFERENCE TO RELATED APPLICATIONS

This application is based upon and claims the benefit of priority from the prior Japanese Patent Application No. 2014-027464, filed on Feb. 17, 2014, the entire contents of which are incorporated herein by reference.

### FIELD

The present invention is related to a technology for executing a match game between terminals.

### BACKGROUND

Currently, the spread of mobile communication terminals such as smartphones is progressing. These types of communication terminals allow games to be enjoyed easily at any time. Many of these games allow not only single users to enjoy but matches between pairs of users by using the communication function of communication terminals.

In addition, instant messenger which supports chatting between users using communication terminals is also spreading widely. In instant messenger, the connection between users (sometimes referred to as friend relationship below) is set in advance. A technology in which an instant messenger and game are linked in order to use this connection making it possible to easily specify the match opponent of a game is disclosed for example in Japanese Laid Open Patent 2009-148580.

In the technology disclosed in Japanese Laid Open Patent 2009-148580, each user can confirm a win or loss in each game. Depending on the method of enjoying a game, there are match methods including not only win and losses in game units but also matches where the highest score are competed for over a number of games. However, the highest score of each user are often provided in a ranking format with all the past results of every user who can initiate the game application for each game. As a result, when chatting with more than one specific partner (user), it was difficult to understand the match results in the case where a user wished to compete in a game. For example, only the results of other users or results buried in past games could be obtained in the ranking format conventionally provided, it was necessary for each user to announce their own score after a game had finished and thus the match results of the game were difficult to understand.

One object of the present invention is to easily understand the results of a game when playing a game with a specific partner as when chatting.

### SUMMARY

According to one embodiment of the present invention, there is provided a non-transitory computer-readable medium storing a program for causing a computer to execute a process including sending first data for setting at least one second user to be an opponent of a game and a match time of the game to a server based on an instruction input by a first user, displaying a screen of the game, and receiving second data according to a result of the game of the first user in a collection period determined based on the match time from the server and displaying game result data on a chat screen for chatting in a group including the first user and the second user based on the second data.

According to one embodiment of the present invention, there is provided a non-transitory computer-readable medium storing a program for causing a computer to execute a process including displaying an indicator for receiving a start instruction from each user of the game, the match time being set by each user, on a chat screen for a plurality of users to chat based on first data received from the server, displaying the game screen when the start instruction of the game is received, and receiving second data from the server according to a result of the game of each user in a collection period determined based on the match time and displaying the result on the chat screen based on the second data.

According to one embodiment of the present invention, there is provided a server configured to send data for providing a chat screen for a plurality of users to chat to a terminal of the plurality of users, send data to the terminal for displaying an indicator on the chat screen for receiving a start instruction of a game linked to a game server from each user, send data for displaying the screen of the game to the terminal instructed to start when a start instruction of the game is received by the terminal, receive a result of the game of each user from the server in a collection period based on a match time determined in advance in the game server from any of the terminals, and send data for displaying the result of the game on the chat screen to each terminal.

### BRIEF DESCRIPTION OF THE DRAWINGS

FIG. 1 is a block diagram showing a structure of messenger system in a first embodiment of the present invention;

FIG. 2 is a block diagram showing a game result provision function in a first embodiment of the present invention;

FIG. 3 is a diagram for explaining game result collection data in a first embodiment of the present invention;

FIG. 4 is a communication flow diagram showing the processes of the messenger system in a first embodiment of the present invention;

FIG. 5 is a diagram showing a startup screen immediately after starting a game application in a first embodiment of the present invention;

FIG. 6 is a diagram showing an invitation group specification screen in a first embodiment of the present invention;

FIG. 7 is a diagram showing a match time specification screen in a first embodiment of the present invention;

FIG. 8 is a diagram showing a chat screen displaying an invitation message in a first embodiment of the present invention;

FIG. 9 is a diagram showing a game screen in a first embodiment of the present invention;

FIG. 10 is a diagram showing retry screen after each game is completed in a first embodiment of the present invention;

FIG. 11 is a diagram showing a chat screen displaying a result message in a first embodiment of the present invention;

FIG. 12 is a communication flow diagram showing the processes of a messaging system in a second embodiment of the present invention;

FIG. 13 is a diagram showing a chat screen in a second embodiment of the present invention;

FIG. 14 is a diagram showing a screen for indicating the start of a game in a second embodiment of the present invention;

FIG. 15 is a diagram showing a screen for specifying a name of a game in a second embodiment of the present invention; and

FIG. 16 is a diagram showing a screen for specifying a match time in a second embodiment of the present invention.

### DESCRIPTION OF EMBODIMENTS

A game system in one embodiment of the present invention is explained below in detail while referring to the diagrams. The embodiments described below are an example of the present invention and the present invention is not limited to these embodiments.

### First Embodiment

A game system in a first embodiment of the present invention is explained below in detail while referring to the diagrams.

### SUMMARY

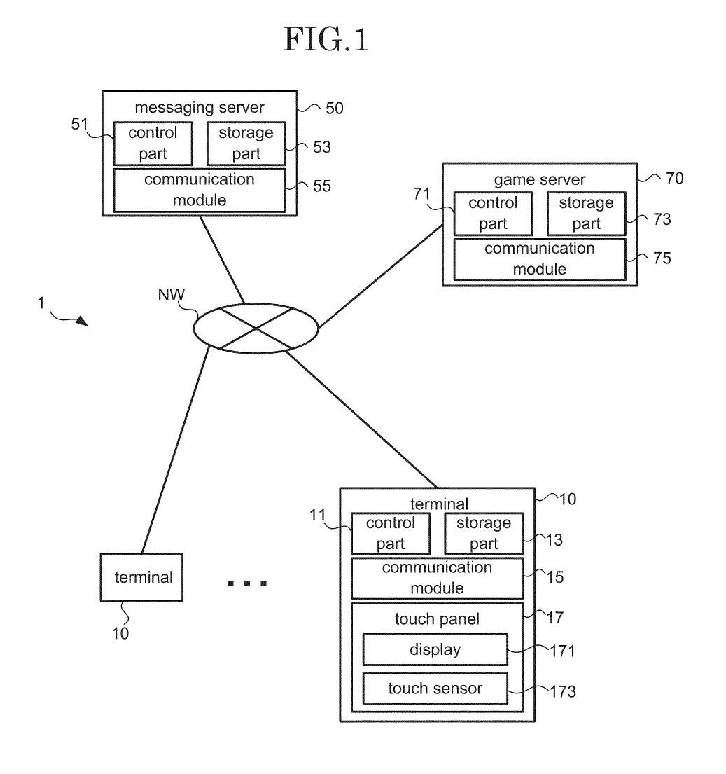

FIG. 1 is a block diagram showing a structure of a game system in the first embodiment of the present invention. A messaging system 1 includes a terminal 10, a messaging server 50 and game server 70. The terminal 10, messaging server 50 and game server 70 are connected to a network NW such as the internet or communication network and can send and receive data between each other.

The terminal 10 in this example is a smartphone that can connect to the network NW via a communication station. The terminal 10 may be a terminal which can connect to the network NW such as a mobile phone or mobile game device etc. In addition, the terminal 10 is not limited to a mobile terminal but may also be a stand-alone type terminal.

The messaging server 50 provides a messaging service for executing a chat etc between users of the terminal 10 and provides a chat screen for chatting between users of each terminal 10 for example. Furthermore, although the chat screen is explained as a screen mainly using text data, image data or voice data can also be provided.

The game server 70 is for managing games on the terminal 10 and manages the results of game between each user for example.

In the example shown in FIG. 1, although the messaging server 50 and game server 70 are described as individual servers, the present invention is not limited to this. That is, the functions of each of the messaging server 50 and game server 70 may be realized using a plurality of servers in collaboration. In addition, the messaging server 50 and game server 70 may be realized in the same server.

The messaging system 1 in the first embodiment provides a game between users of the terminal 10 based on the other user who becomes a match opponent specified by a user and the match time and provides the match result of the game. This match result is managed in the game server 70 and is provided in a chat screen displayed in each terminal 10 by the messaging server 50. This chat screen is for a plurality of users playing at least a game match to chat.

The structure for realizing the functions of the game system 1 described above is explained below. First, the structure of the terminal 10, messaging server 50 and game server 70 are explained.

### [Hardware Structure of Terminal 10]

As is shown in FIG. 1, the terminal 10 includes a control part 11, a storage part 13, a communication module 15 and touch panel 17. Furthermore, although not shown in FIG. 1, a structure arranged in a usual smartphones such as an operation button, microphone, speaker, memory card slot, head phone terminal etc may also may arranged.

The control part 11 includes a calculation processing circuit such as a CPU and a memory etc. The control part 11 executes programs stored in the storage part 13 and realizes each type of function in the terminal 10. A chat screen or game screen are displayed in a display 17 of the terminal 10 and native applications such as chat or games are included in the program. A messaging application for providing a chat screen for users to chat and a game application for providing a game screen for users to play games are each independent applications.

These programs are downloaded to the terminal 10 via the network NW and stored in the storage part 13. Furthermore, the programs may be provided in a state stored in a computer readable storage medium such as a magnetic storage media, magneto-optic storage media or semiconductor memory. In this case, the terminal 10 may be arranged with device that reads a storage media. In addition, the programs may be stored in advance in the storage part 13.

The storage part 13 is a storage device such as a non-volatile memory or hard disk. The programs described above are stored in the storage part 13.

The communication module 15 is connected with the network NW using control of the control part 11 and performs sending and reception of data with other devices connected to the network NW.

The touch panel 17 is formed from a display 171 and touch sensor 173. The display 171 is a display device such as a liquid crystal display or organic EL display and displays various screens such as a chat screen or game screen using control by the control part 11.

The touch sensor 173 is a device which receives input operations from a user and outputs signals according to the input operations. User operations from a user are received by the touch sensor 173 via a pointing device such as a stylus pen or contact from the finger of a user. In the explanation below, an input operation such as contact of a finger of a user at a position corresponding to an operation button displayed in the display 171 are simply expressed as a user operating an operation button.

### [Hardware Structure of Messaging Server 50]

The messaging server 50 includes a control part 51, storage part 53 and communication module 55.

The control part 51 includes a calculation processing circuit such as a CPU and a memory etc. The control part 51 executes programs stored in the storage part 53 and realizes each function in the messaging server 50 such as a messaging service function for displaying a chat screen in the terminal 10 which provides a chat service between users of the terminal 10.

These programs may be provided in a state stored in a computer readable storage medium such as a magnetic storage media, magneto-optic storage media or semiconductor memory. In this case, the messaging server 50 may be arranged with device that reads a storage media. In addition, the programs may be stored in advance in the storage part 53. Furthermore, these programs may be downloaded to the messaging server 50 via the network NW and stored in the storage part 53.

The storage part 53 is a storage device such as a non-volatile memory or hard disk. Programs executed by the control part 51 are stored in the storage part 53. In addition, friend relationship data and group data are stored in the storage part 53. The friend relationship data stipulates a connection between users of terminal 10. The group data stipulates a group which unites users selected from users specified by the friend relationship data. Furthermore, the friend relationship data and group data are used in a messaging application. Because a game application is a native application independent of a messaging application as described above, it is necessary to receive a certain authentication in order to use this data. For example, a game application can use this data by receiving authentication in advance from the messaging server 50.

The communication module 55 is connected to the network via control of the control part 51 and sends and receives data with other devices connected with the network NW.

### [Hardware Structure of the Game Server 70]

The game server 70 includes a control part 71, storage part 73 and communication module 75. In this example, only the functions realized by executing programs are different between the messaging server 50 and game server 70 and the hardware structure is the same.

The control part 71 includes a calculation processing circuit such as a CPU and a memory etc. The control part 71 executes programs stored in the storage part 73 and realizes each function in the game server 70 such as a game provision function which provides games to users of the terminal 10 by displaying a game screen on the terminal 10 and manages game results.

The storage part 73 is a storage device such as a non-volatile memory or hard disk. The programs described above are stored in the storage part 73. In addition, data related to games played by users of the terminal 10, for example, result data which represents the results of a game, and game result collection data which represents the game results within a match time, are stored in the storage part 73.

Since the remaining structure is almost the same as the messaging server 50 described above, an explanation is omitted.

### [Function Structure of the Messaging System 1]

The messaging system 1 is realizes a function for providing the results of games played by a plurality of users of the terminal 10 (sometimes referred to below s game result provision function) by the function realized in the messaging server 50 and function realized in the game server 70.

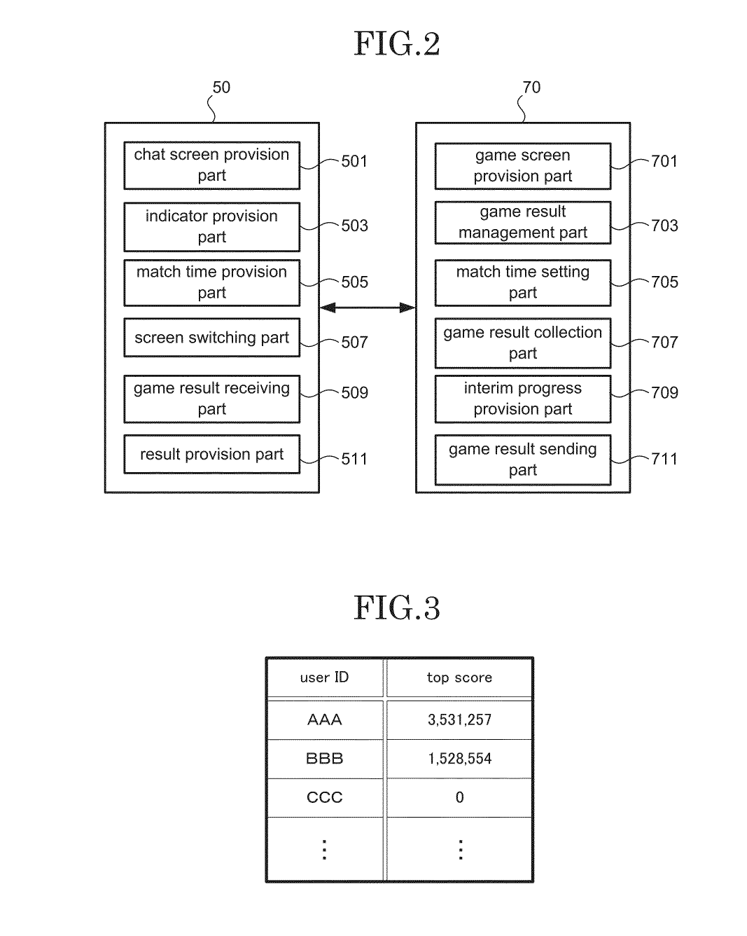

FIG. 2 is a block diagram showing a game result provision function in the first embodiment of the present invention. Each function of a chat screen provision part 501, indicator provision part 503, match time provision part 505, screen switching part 507, game result receiving part 509 and result provision part 511 are realized in the messaging server 50. Each function of a game screen provision part 701, game result management part 703, match time setting part 705, game result collection part 707, interim progress provision part 709 and game result sending part 711 are realized in the game server 70. A game result provision function is realized using each of these functions.

The chat screen provision part 501 provides a chat screen (for example, refer to FIG. 8) to the terminal 10. The chat screen is displayed on the display 171 of the terminal 10 when chat is carried out between a user of the terminal 10 (referred to below as user A for the purpose of explanation) and at least one friend user (referred to below as user B for the purpose of explanation) among friend users (referred to below as user C for the purpose of explanation) who is in a friend relationship with the user. User A may specify user B for chatting by specifying a group to which a user belongs among user C. A user belonging to a group is set in advance by any user and is stored as the group data described above in the storage part 53.

The indicator provision part 503 displays an indicator (for example, refer to the invitation message in FIG. 8), on a chat screen for starting a game when there is an invitation to play a game from a user in a friend relationship.

The match time provision part 505 displays the indicator described above and the match time of a game (for example, refer to FIG. 8) set by a user on a chat screen.

When an instruction for starting a game is received by an operation of a user to the indicator displayed on the chat screen, the screen switching part 507 switches the chat screen to a game screen. This is realized for example by starting a game application installed in the terminal 10. In addition, the screen switching part 507 switches the game screen to the chat screen on the display 171 of the terminal 10 in order to display the result of a game when the match of a game is completed. This is realized for example by starting a chat application installed in the terminal 10.

The game result sending part 509 sends the match result of a game collected in the game server 70.

The result provision part 511 displays the match results of a game received from the game server 70 on the chat screen.

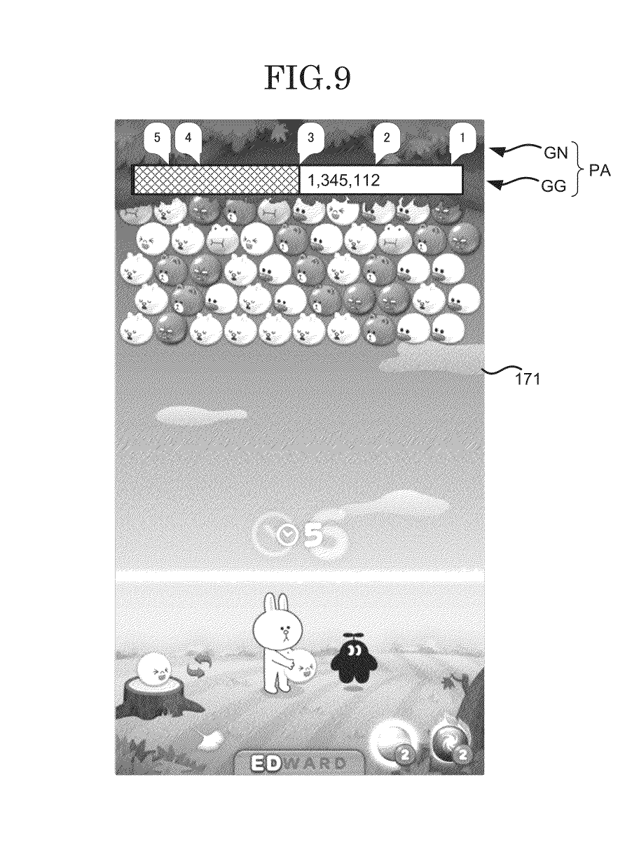

The game screen provision part 701 provides a game screen (for example, refer to FIG. 9), to the terminal 10. A game played by a user in this example is a game in which each user progresses separately. That is, the progress of the game of the user is not changed depending on the state of the progress of the game of another user. Furthermore, the game in the example is not limited to a game in which each user progresses separately but may also be a game in which the progress of the game of a user is changed according to the progress of the game of each user. For example, in the case where a certain user carries out a certain action during the game, the game may be composed for the user's highest score to reduce by changing the progress of the other user's game so as to obstruct the progress of the game in the user's game.

The game result management part 703 manages the results a game of each user. For example, various changing parameters are included in the game result by a user playing a game such as current highest score or number of games played etc.

The match time setting part 705 sets the match time of a game based on an instruction from a user.

The game result collection part 707 accumulates the results of games played by each user during a collection period from the start of a match game until the match time elapses. In this example, the accumulated game results are the highest score of each user and are stored as game result collection data in the storage part 73. Furthermore, the collection period does not have to match a period from the start of the match game until the match time elapses. The correction period may be a period until slightly before the match time elapses or until slightly after the match time elapses and the end of the collection period may be determined based on the match time specified by a user.

FIG. 3 is a diagram for explaining the game result collection data in the first embodiment of the present invention. The game result collection data is data formed by correlating a user ID and highest score. A user ID is an ID allocated to a user of each terminal 10. The game result collection data is generated corresponding to a match each time a match of a game is played. In the case where a match opponent is specified in a group by a user, a group ID (an iD allocated to a group) is correlated in the game result collection data. The generated game result collection data is recorded with the highest score of each user and continuously refreshed during the collection period while a match of game is played. In the example in FIG. 3, a user with user ID [AAA] has a highest score of [3,531,257]. A user with the ID [CCC] has a highest score of [0] and a game result is not present. That is, a state whereby it is not shown whether a game has been played or an initial game has not finished. Furthermore, in the case where the past highest scores have already been refreshed during the progress of a game, the highest score in the game collection result data is refreshed in sequence even while a game is in progress.

The explanation continues returning to FIG. 2. The interim progress provision part 709 provides the current highest score of each user as a progress state (for example, refer to FIG. 9) of a game of each user during a match in a game screen while referring to the game result collection data.

The game result sending part 711 sends the highest score of each user collected in the collection period to the messaging server 50 while referring to the game result collection data after the match time has elapsed.

### [Operation of the Messaging System 1]

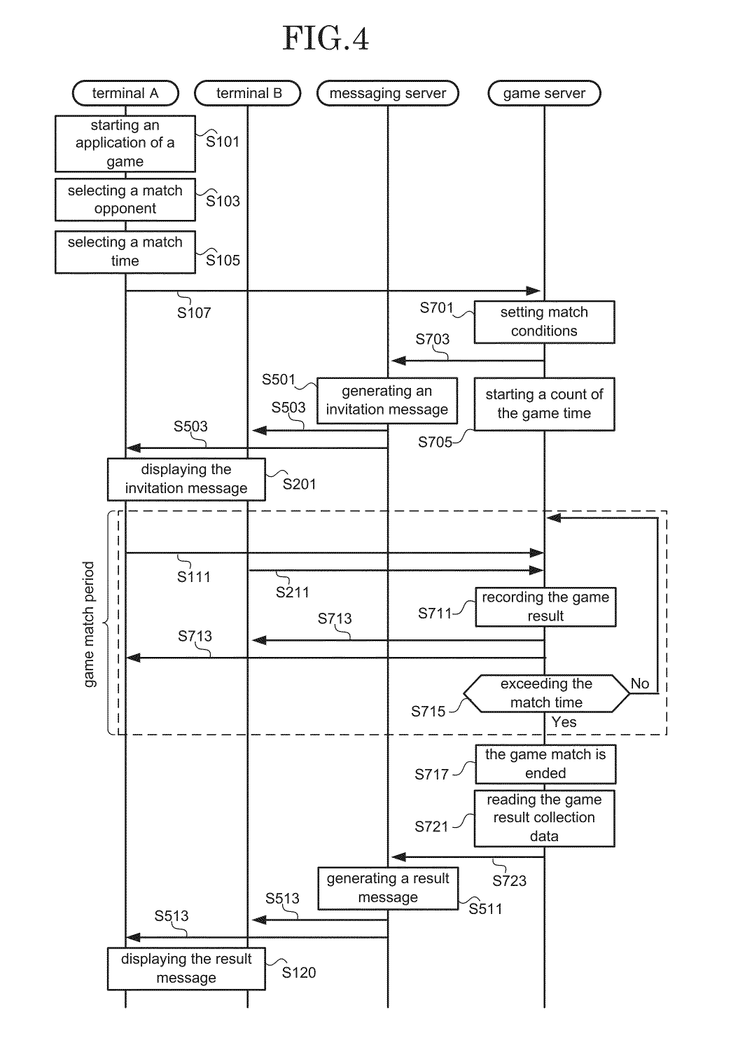

The operation in the functional structure of the messaging system 1 described above is explained using the communication flow diagram shown in FIG. 4. Furthermore, the chat screen and game screen displayed in the display 171 of the terminal 10 is explained. In the explanation below, the terminal 10 is sometimes shown as terminal A and terminal B. The terminal A is the terminal A used by user A which proposes starting a match of a game. The terminal B is the terminal 10 used by user B invited to a match of a game by user A. As described above, user A and user B are stipulated as a friend relationship using friend relationship data and are stipulated as belonging to the same group using group data. Furthermore, user B may be a plurality of users. User B is explained as representing one person also in the case of a plurality of users.

FIG. 4 is a communication flow diagram showing the processes of a messaging system in the first embodiment of the present invention. First, terminal A starts the application of a game to be played via an instruction from user A (step S101). When the application is started, a start screen is displayed on the display 171.

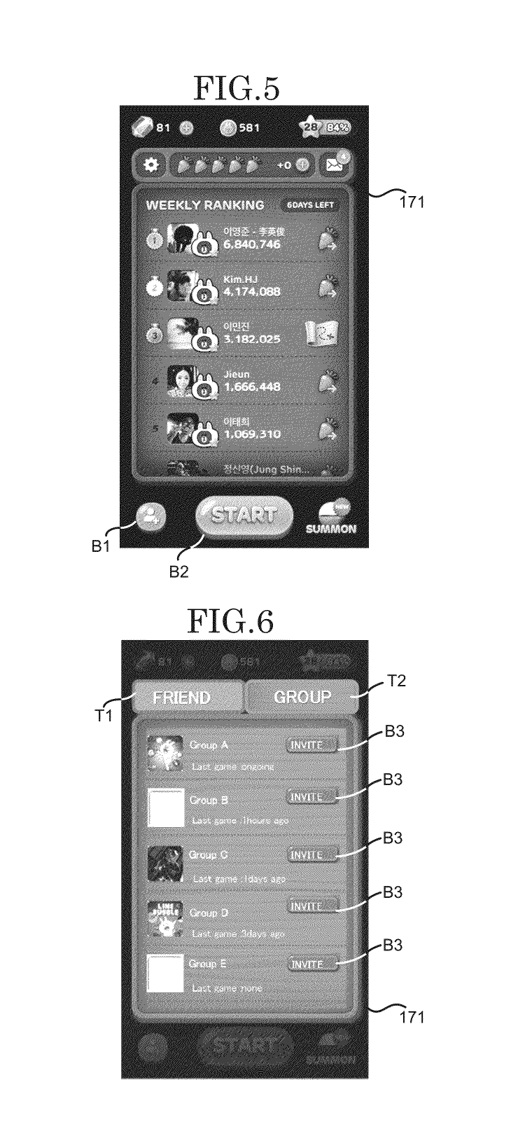

FIG. 5 is a diagram showing a start screen immediately after a game application is started in the first embodiment of the present invention. In the present example, the week's ranking highest scores are displayed on the start screen displayed on the display 171. The week's ranking is received from the game server 70. In addition, a match opponent specification button B1 and start button B2 are displayed on the start screen. When a user operates the start button B2, a game which the user can enjoy by themselves not a match with another opponent is started. On the other hand, when a user operates the match specification button B1, a screen for specifying a user for inviting a match opponent (invitation user specification screen) or screen for specifying a group (invitation group specification screen) is displayed.

FIG. 6 is a diagram for showing an invitation group specification screen in the first embodiment of the present invention. A friend tab T1 and group tab T2 are displayed in the invitation group specification screen of the display 171, and is in a state where the group T2 is selected by an operation of a user. A group list which can be specified as a match opponent is displayed in the invitation group specification screen and an invitation button B3 for inviting a user belonging the group is displayed next to the name of each group. When a user operates the invitation button B3, the corresponding group is specified as the match opponent. Furthermore, when the friend tab T1 is selected by an operation of a user, the screen switches to the invitation user specification screen and a user list which can be specified as a match opponent is displayed instead of a group list.

Returning to FIG. 4, when user A operates the invitation button B3 in invitation group specification screen and a group which becomes a match opponent is selected (step S103), a screen (match time specification screen) for specifying the match time is displayed. As described above, a user belonging to the group specified as a match opponent is called user B. Terminal B is used by user B. Furthermore, when the friend tab T1 is operated to switch the screen to an invitation user specification screen, one or more users and not a group may be selected as a match opponent.

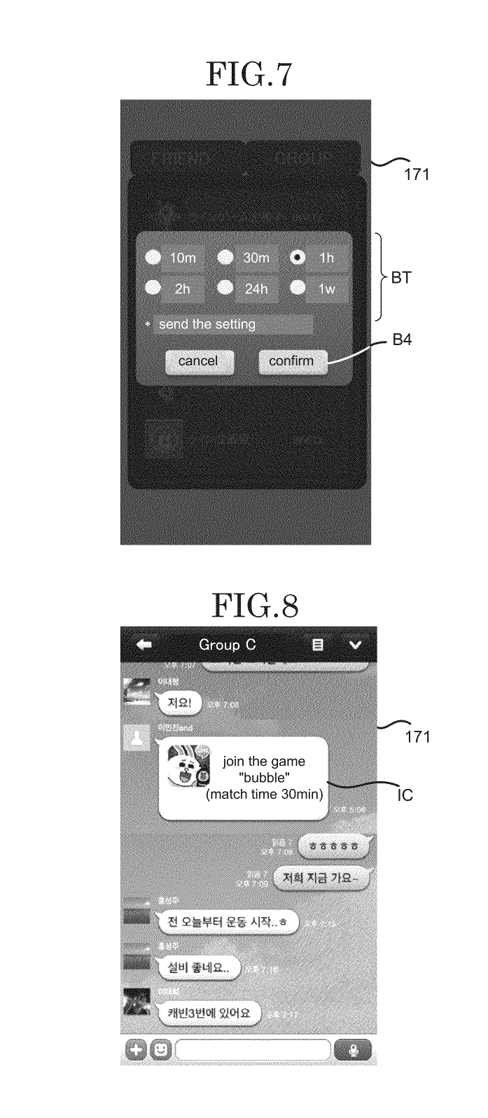

FIG. 7 is a diagram showing a match time specification screen in the first embodiment of the present invention. An area BT for specifying a match time and confirmation button B4 are displayed in the match time specification screen in display 171. In this example, the match time is displayed so that either of six types of time period (10 minutes, 30 minutes, 1 hour, 2 hours, 24 hours, 1 week) set in advance can be selected. Furthermore, a narrower selection tree may be displayed, for example, a user may input a time period in units of 30 seconds or 1 minute etc.

Returning to FIG. 4, when a match time is specified by user A selecting a match time and operating the confirmation button B4 in the match time specification screen (step S105), match condition data which shows the type (name) of game which starts, match opponent and match time are sent to the game server 70 from the terminal A (step S107).

When the match conditions are received from the terminal A, the game server 70 sets the match condition data which shows user B belonging to a group specified as a match opponent and match time as the match conditions of the present game (step S701). In addition, the game server 70 sends the match condition data to the messaging server 50 (step S703) and starts a count of the game time (step S705).

When the match condition data is received, the messaging server 50 generates an invitation message for notifying user B shown by the match condition data (user specified as a match opponent) (step S501), and sends the invitation message to the terminal A and terminal B for displaying the invitation image in a chat screen of a group to which user A and user B participate (step S503). In the case where only chat screen is mentioned below, a chat screen of a group (group specified in step S103) in which user A and user B participate is shown.

When the invitation message is received from the messaging sever 50 in the terminal A and terminal B, a chat screen is displayed in the display 171 of the terminal A and terminal B and the invitation message is displayed in the chat screen (step S201).

FIG. 8 is a diagram showing a chat screen displaying an invitation message in the first embodiment of the present invention. FIG. 8 shows a chat screen for user A and user B belonging to a specified group (group C in this example) to chat and an invitation message IC is displayed in the chat screen. In this example, the game type (name) and match time are displayed in the invitation message IC. Furthermore, the invitation message IC may function as an indicator for at least the start of a game and the display contents may not have to be a game type (name) and match time.

In addition, when a part of the invitation message IC is operated by a user, an application of that named game is started. That is, the invitation message functions as an indicator for starting a game. Furthermore, the indicator for starting game may be a different icon (image display), or link (text display) different to the invitation message.

When a user operates an invitation message IC (indicator) on the chat screen displayed in the display 171 of terminal B, an application of the game to be played is started. By this operation, the chat screen switches to a game screen and the game is started. The results of the game (a score in this example) are sent to the game server 70 after each single game is completed in the terminal A and terminal B (step S111, S211). Furthermore, user A of terminal A may start game using a running game application without operating the invitation message IC.

When the game result is received from terminal A or terminal B, the game server 70 records the game result in game result collection data (step S711). At this time, the highest score of user ID which indicates a user of terminal 10 which is the sending source of the game result is referred to, and if the score of the game result which is received exceeds this highest score, the received score is recorded so that the game result collection data is refreshed.

When the game result collection data is refreshed, the game server 70 sends the refreshed game results (user data and highest score) to the terminal A and terminal B (step S713). The sent game results may also be game result collection data. Furthermore, apart from this, the game start time and necessary data may be sent and received between the terminal A and terminal B and the game server 70.

In the case where counted game time has not exceeded the match time (step S715; No), the game server 70 waits for the game result from the terminal A and terminal B and continues to record the game result if the results is received. On the other hand, if the game time has exceeded the match time (step S715; Yes), refreshing of the game result collection data is ended and the game match is ended (step S717). At this time, the game server 70 may also notify the terminal A and terminal B that the match time of the game has ended.

In the case where the terminal A and terminal B are notified that the game match time has ended, the game can be controlled to end forcibly, or the game can be continued. Even in the case where the game is continued, this is not reflected in the game result collection data even if the game server subsequently receives the game result. Furthermore, the fact that the game match time has ended may be displayed in the terminal A and terminal B. The end of the match time may be displayed the game screen or the chat screen. In the case where the end of the match time is displayed on the chat screen, the game server 70 notifies the terminal A and terminal B via the messaging server 50. At this time, the game screen displayed in the display 171 of the terminal A and terminal B is switched to the chat screen.

Here, an example of a game screen displayed in the display 171 of terminal A and terminal in the game match time is explained.

FIG. 9 is a diagram showing a game screen in the first embodiment of the present invention. A display area PA which shows the interim progress corresponding to the state of a game of each user is arranged on the upper part of the game screen in the display 171. A gage GG which shows the current highest score of a user of terminal 10 and an icon GN which shows the highest score of another user are displayed in the display area PA. Characters which show the current standing of a user during a match are written in the icon GN. In the example in FIG. 9, the user of the terminal 10 in this game screen is in [third place] among five users, and the current highest scores are [1,345,112]. Furthermore, the interim progress ranking may be displayed in the chat screen periodically or when the ranking of a user changes. In this case, the game result may also be sent to the messaging server 50 from the game server 70.

The display contents of the display region PA are determined based on the game result sent from the game server 70 when the game result collection data is refreshed. Therefore, when the highest score of any user of a match opponent is refreshed during a game, the contents of the display area are refreshed in sequence. In addition, when the highest score in the game of the terminal 10 is refreshed, the display of the gage GG may also change at the same time.

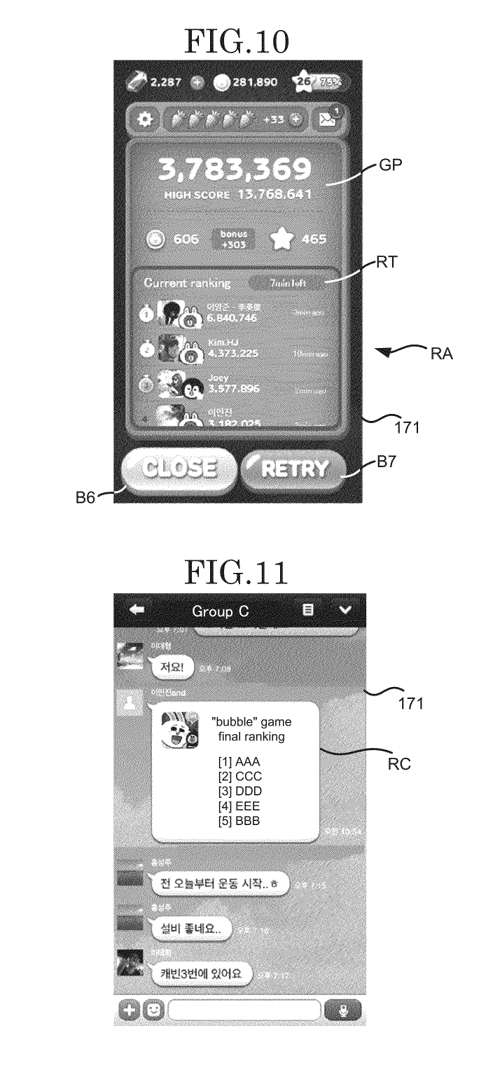

FIG. 10 is a diagram showing a retry screen after each game is finished in the first embodiment of the present invention. When one game has ended, as is shown in FIG. 10, a retry screen is displayed in the display 171. The current game score, a display area GP showing the current highest score, a display area RA showing the ranking of each user during the current match, and a display area RT showing the remaining time of the match time are displayed in the retry screen. This data may also be received from the game server 70. In addition, a close button B6 for ending a game and a retry button B7 for restarting a game are displayed in the retry screen. Furthermore, it is possible to rejoin the match of a game by restarting a game by either operating an indicator in the chat screen of starting the game application even in the case where a game has ended.

Returning to FIG. 4, when a match has ended (step S717), the game server 70 reads the game result collection data (step S721), and sends to the messaging server 50 (step S723).

When the game result collection data is received, the messaging server 50 generates a result message showing the game result (step S511) and sends the message to the terminal A and terminal B (step S513). The result message is displayed on the chat screen in terminal A and terminal B (step S120).

FIG. 11 is a diagram showing a chat screen displaying a result message in the first embodiment of the present invention. FIG. 11 is a chat screen for users (user A and user B) playing a game to chat, corresponds to the chat screen in FIG. 8 and displays a result message RC. The type of game played and the final ranking of the highest score of each user are displayed in the result message RC. The form of this display is one example and is not limited to the ranking of all users participating in a match. The ranking (for example, the top three) of some of the users may be displayed. This completes the explanation of the operation of the messaging system 1.

In this way, it is possible to realize the game result provision function described above in the message system 1 in the first embodiment of the present invention. In this way, a match time is determined and a game is played when playing a game between users in a friend relationship who can chat. In addition, the game results in a game match period determined based on this match time can be collected for each user and it is possible to display the ranking of each user in the game match time period on a chat screen in which at least users participating in a match can chat. Therefore, each player that played the match of a game can easily understand the game result using the sense of extended chat in the case of playing a game with a specific opponent who they are chatting with.

### Second Embodiment

In the first embodiment, a messaging system 1 in which a user A starts a game application and specifies the match conditions was explained. In the second embodiment, a messaging system 1A in which it is possible to specify the match conditions on the chat screen is explained. The operation of the messaging system 1A in the second embodiment is explained. Furthermore, the functional structure of the messaging system 1A, hardware structure of the terminal 10, messaging server 50 and game server 70 is the same as in the first embodiment and therefore an explanation is omitted.

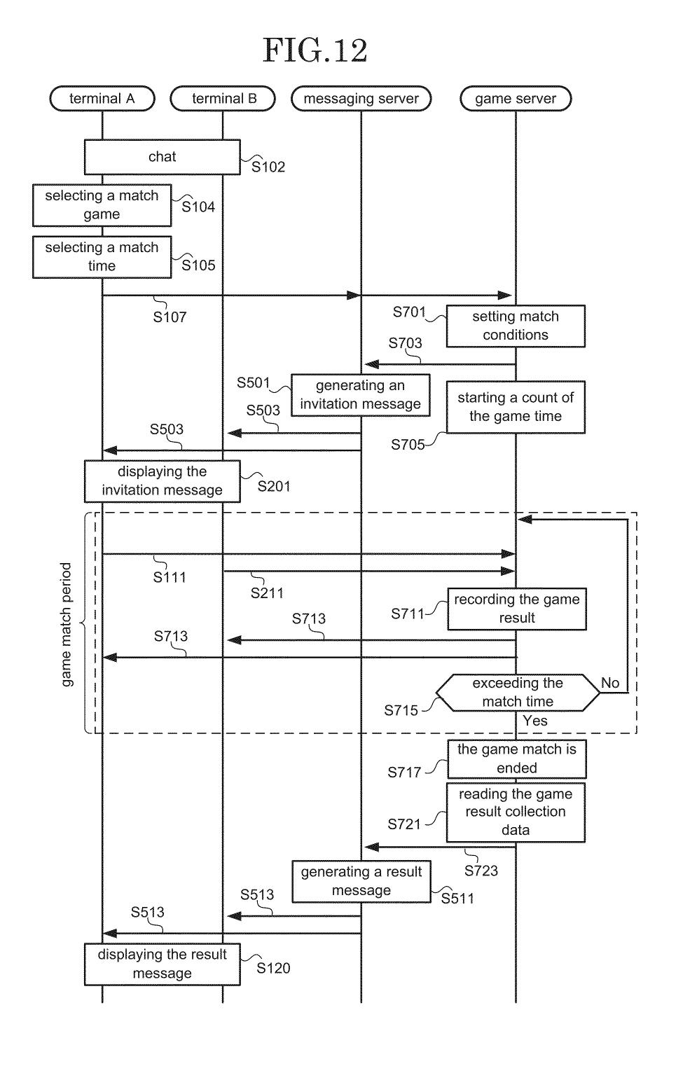

FIG. 12 is a communication flow diagram showing the processes of a messaging system in the second embodiment of the present invention. In the second embodiment, first a chat screen is provided from the messaging server 50 and user A of terminal A and user B of terminal B chat (step S102). User A specifies the type (name) of the game to be played on the chat screen (step S104), and when the match time is specified (step S105), the type (name) of the game to be played and match condition data which shows the match opponent and match time is sent from the terminal A to the game server 70 via the messaging server 50 (step S107).

Here, the match opponent is a user or group which can participate in a chat executed in step S102 and in this example is user A and user B. Furthermore, the type (name) of the game to be played and match condition data which shows the match time may be sent to the messaging server 50 from the terminal A. In this case, the user or group which can participate in the chat executed in step S102 is judged in the messaging server 50, that user or group is added to the match condition data as playing user and may be sent to the game server 70. Because the processes after this are the same as in the first embodiment, an explanation is omitted. Furthermore, the chat screen which displays a result message in step S120 is the chat screen displayed in step S102.

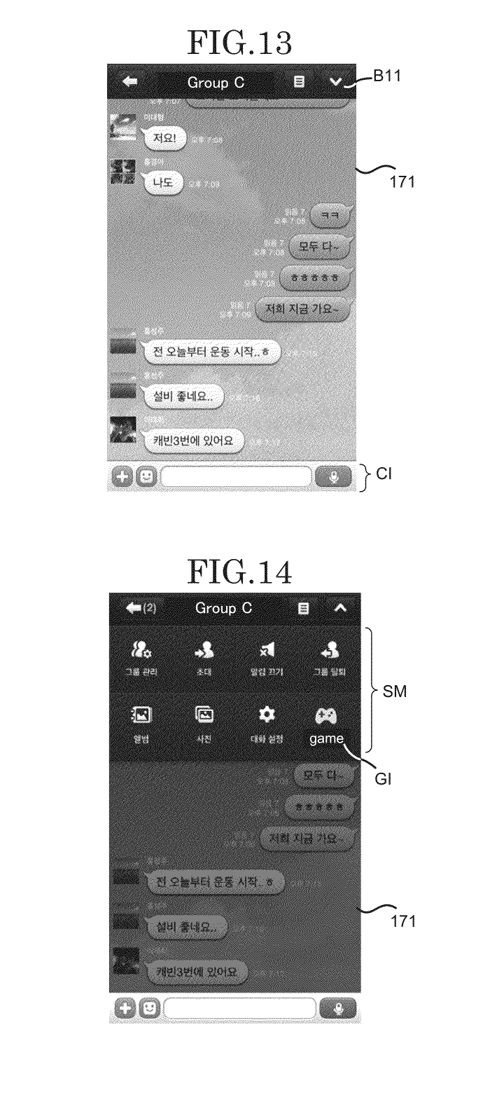

An example of a method for specifying the type (name) of the game and method for specifying the match time from a chat screen is explained using the display contents of the display 171 shown in FIG. 13 to FIG. 16.

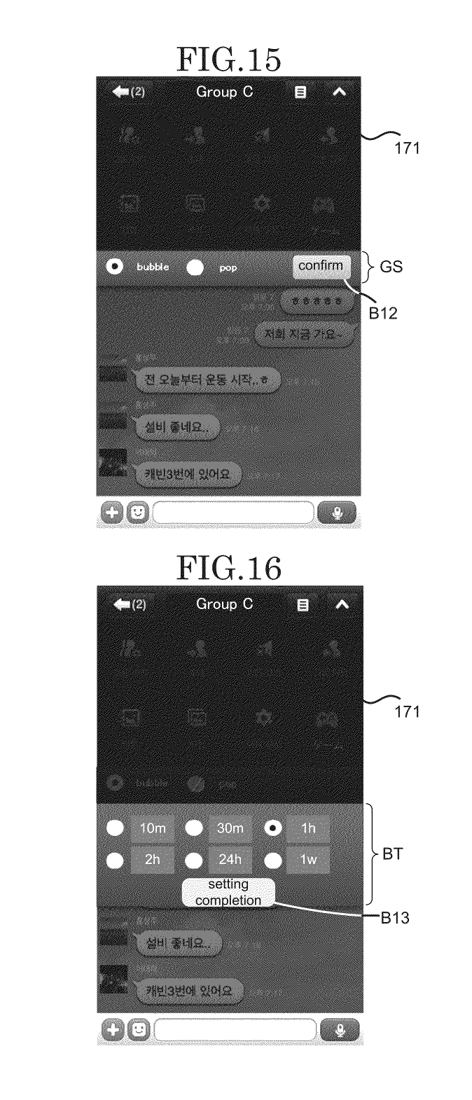

FIG. 13 is a diagram showing a chat screen in the second embodiment of the present invention. FIG. 14 is a diagram showing a screen for instructing the start of a game in the second embodiment of the present invention. FIG. 15 is a diagram showing a screen for specifying the type (name) of game in the second embodiment of the present invention. FIG. 16 is a diagram showing a screen for specifying a match time in the second embodiment of the present invention.

The chat screen shown in FIG. 13 is the screen displayed in step S102 in FIG. 12. An input area CI for inputting characters for chatting and a setting button B11 are displayed in the chat screen. When user A operates the setting button B11, the setting menu SM shown in FIG. 14 is displayed. When the game icon GI displayed in the setting menu SM is operated, an area GS for selecting the type of game is displayed as is shown in FIG. 15. In this example, the games [bubble] or [pop] can be selected and a confirmation button B12 for confirming the selected game is displayed. When user A operates the confirmation button B12, an area BT for setting the match time and a setting completion button B13 are displayed as is shown in FIG. 16. Similar to the first embodiment, user A selects the match time and the match time is specified by operating the setting completion button B13.

In this way, it is possible to specify the match conditions in the chat screen and therefore not limited to specifying the match conditions after a game application is started when a game is played between specific users in a friend relationship.

### Other Embodiments

In the embodiments described above, although the result of a game in the collection period is recorded as game result collection data by the game server 70, the game result collection data may also be recorded in the messaging server 50. In this case, the match time may be managed in the messaging server 50 and the game server 70 may correlate the game result with data which identifies the terminal 10 and send it to the messaging server 50 each time a result of game is received from the terminal 10.

In the embodiments described above, although a game is provided to a user by starting a game application in the terminal 10, a game may also be provided to a user via a web browser from the game server 70.

In the embodiments described above, there are cases where an invitation to a match in a game is received from a plurality of groups in the case where a plurality of specified users belong to a plurality of groups. In this case, an invitation message IC is displayed on the chat screen of each group in the terminal 10 of that user. This user can play a game in that group by operating the invitation message IC on the chat screen of the group that user wishes to join. It is also possible to temporarily switch to a match of a game of a different group by operating the invitation message IC on the chat screen of that group within the match time of a group. In this case, although the game result (highest score) of a specific user is included in a plurality of game result collection data, it is possible to determine the game result from the result of a match of any game or from the group ID correlated with the game result collection data.

In the embodiments described above, when the invitation message IC is displayed on a chat screen (or when an invitation message IC is received in a terminal), there are cases when the application of a game to be started by operating the invitation message IC is not installed in the terminal B (there are also cases when the application is not installed in the terminal A in the second embodiment). In this case, the application does not have to be started but the terminal 10 may be controlled as follows. When the invitation message IC is operated, a screen for downloading the application is displayed in the display 171 of the terminal 10 in order to encourage the user to download that application. In addition, when the invitation message IC is operated, the application may also be automatically downloaded to the terminal 10.

What is claimed is:

1. A non-transitory computer-readable medium storing a program for causing a computer to execute a process, comprising:
sending first data for setting at least one second user to be an opponent of a game and a match time of the game to a server based on an instruction input by a first user;
displaying a screen of the game; and
receiving second data according to a result of the game of the first user in a collection period determined based on the match time from the server and displaying game result data on a chat screen for chatting in a group including the first user and the second user based on the second data.

2. The non-transitory computer-readable medium according to claim 1, wherein the second user of the game to be a match opponent is set by sending the group stipulated in advance to the server based on an instruction input by the first user.

3. The non-transitory computer-readable medium according to claim 1, wherein a screen of the game displayed on a terminal of the first user displays state information corresponding to a state of a game by the second user.

4. The non-transitory computer-readable medium according to claim 1, wherein either screen or the game screen is switched and displayed in a display part of the terminal.

5. The non-transitory computer-readable medium according to claim 1, wherein the progress of the game of the first user is not changed depending on the state of the progress of the game of the second user..

6. The non-transitory computer-readable medium according to claim 1, wherein the progress of the game of the first user is changed depending on the state of the progress of the game of the second user.

7. A non-transitory computer-readable medium storing a program for causing a computer to execute a process, comprising:
displaying an indicator for receiving a start instruction from each user of the game, the match time being set by each user, on a chat screen for a plurality of users to chat based on first data received from the server;
displaying the game screen when the start instruction of the game is received; and
receiving second data from the server according to a result of the game of each user in a collection period determined based on the match time and displaying the result on the chat screen based on the second data.

8. The non-transitory computer-readable medium according to claim 7, wherein the indicator is displayed on the chat screen of the plurality of users chatting.

9. The non-transitory computer-readable medium according to claim 8, wherein the match time can be set in the chat screen.

10. The non-transitory computer-readable medium according to claim 7, wherein the chat screen display the match time set in the game before the game screen is displayed.

11. The non-transitory computer-readable medium according to claim 7, wherein the game screen displayed on the terminal of the user displays state information according to the state of the game of another user.

12. The non-transitory computer-readable medium according to claim 7, wherein either the chat screen or the game screen is switched and displayed in a display part of the terminal.

13. The non-transitory computer-readable medium according to claim 7, wherein the progress of the game of the user is not changed depending on the state of the progress of the game of another user

14. The non-transitory computer-readable medium according to claim 7, wherein the progress of the game of the user is changed depending on the state of the progress of the game of another user.

15. A server configured to:
send first data for providing a chat screen for a plurality of users to chat to a terminal of the plurality of users;
send second data to the terminal for displaying an indicator on the chat screen for receiving a start instruction of a game linked to a game server from each user;
send third data for displaying the screen of the game to the terminal instructed to start when a start instruction of the game is received by the terminal;
receive a result of the game of each user from the server in a collection period based on a match time determined in advance in the game server from any of the terminals; and
send fourth data for displaying the result of the game on the chat screen to each terminal.

16. The server according claim 15, wherein the server is configured to receive the match time from the game server and display on the chat screen before displaying the game screen.

17. The server according claim 15, wherein the game screen displayed on the terminal of the user is displayed according to the state of the game of another user.

18. The server according claim 15, wherein either the chat screen or the game screen is switched and displayed in a display part of the terminal.

19. The server according to claim 15, wherein the progress of the game of the user is not changed depending on the state of the progress of the game of another user.

20. The server according claim 15, wherein the progress of the game of the user is changed depending on the state of the progress of the game of another user.
